(19) United States
(12) Patent Application Publication
(10) Pub. No.: US 2019/0291500 A1
(43) Pub. Date: Sep. 26, 2019

(54) RECESSED MARKER TRAY AND ACCESSORY HOLDER FOR A WRITING SURFACE

(71) Applicant: James R. Gulnick, Mantua, NJ (US)

(72) Inventor: James R. Gulnick, Mantua, NJ (US)

(21) Appl. No.: 15/927,605

(22) Filed: Mar. 21, 2018

(51) Int. Cl. B43K 23/04; B43L 1/10; B43L 1/00

(52) U.S. Cl. CPC B43K 23/04; B43L 1/00; B43L 1/10

(57) ABSTRACT

A storage insert for a writing surface. The storage insert includes a frame and a flange. The frame forms a receptacle and the flange protrudes outwardly from a front edge of the frame. The frame is configured to fit within an opening defined by an inner edge of a writing surface and the flange is configured to retain the frame within the opening.

### BACKGROUND OF THE INVENTION

The present invention relates to marker and accessory holders for writing surfaces and, more particularly, to a recessed marker tray and accessory holder for a writing surface.

Traditional vertical writing surfaces utilize marker trays and chalk holders protrude from the front of the writing surface. Since the marker trays and accessory holders stick out from the front of the vertical writing surfaces, someone may easily bump into the trays while walking by. Further, the writing accessories can fall off the tray or be knocked off by people bumping into them. The accessory holders unnecessarily take up valuable space and can block the movement of furniture especially when situated by a door or in a high traffic area.

As can be seen, there is a need for a recessed marker tray and accessory holder for a writing surface.

### SUMMARY OF THE INVENTION

In one aspect of the present invention, a storage insert for a writing surface comprises: a frame comprising a top panel, a first side panel, a second side panel, a bottom panel and a back panel, wherein the top panel, the first side panel, the second side panel, and the bottom panel comprise a front edge defining an opening leading into a receptacle defined by an inner surface of the frame; and a flange coupled to the front edge of the frame, wherein the flange projects outward and away from the opening beyond outer surfaces of at least two of the top panel, the first side panel, the second side panel, and the bottom panel, wherein the frame is configured to fit within an opening defined by an inner edge of a writing surface and the flange is configured to retain the frame within the opening.

In another aspect of the present invention, a storage insert for a writing surface comprises: a frame comprising a top panel, a first side panel, a second side panel, a bottom panel and a back panel, wherein the top panel, the first side panel, the second side panel, and the bottom panel comprise a front edge defining an opening leading into a receptacle defined by an inner surface of the frame; a flange coupled to the front edge of the frame, wherein the flange projects outward and away from the opening beyond outer surfaces of at the top panel and the bottom panel; and at least one locking rib coupled to the outer surface of the top panel, wherein the locking rib is an angled protrusion made of a resilient material, wherein the frame is configured to fit within an opening defined by an inner edge of a writing surface and the at least one lock rib is configured to resiliently bend and apply a force against the writing surface.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a detail perspective view of an embodiment of the present invention;

FIG. 3 is a cross-sectional view showing an insert partially engaging with a writing surface; and

FIG. 4 is a cross-sectional view taken along line 4-4 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

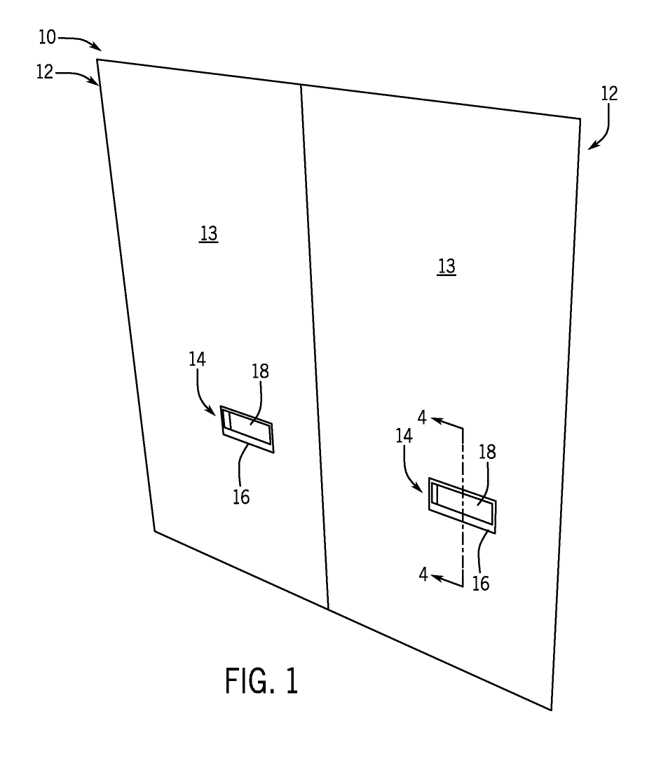

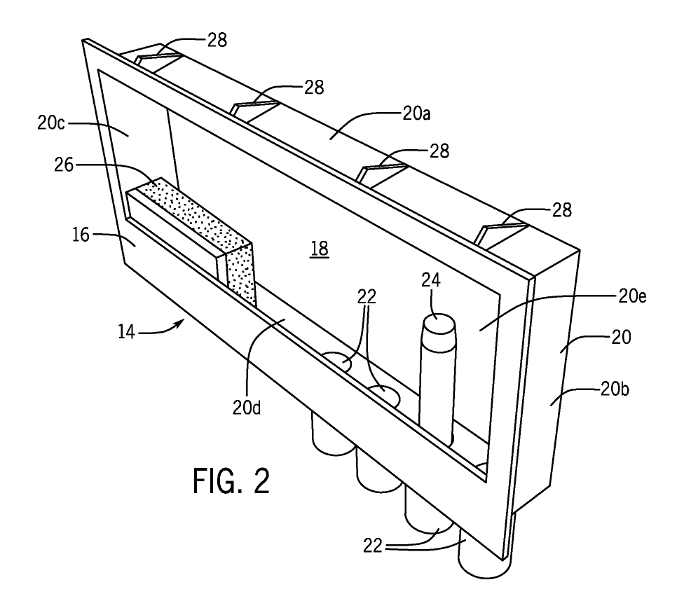

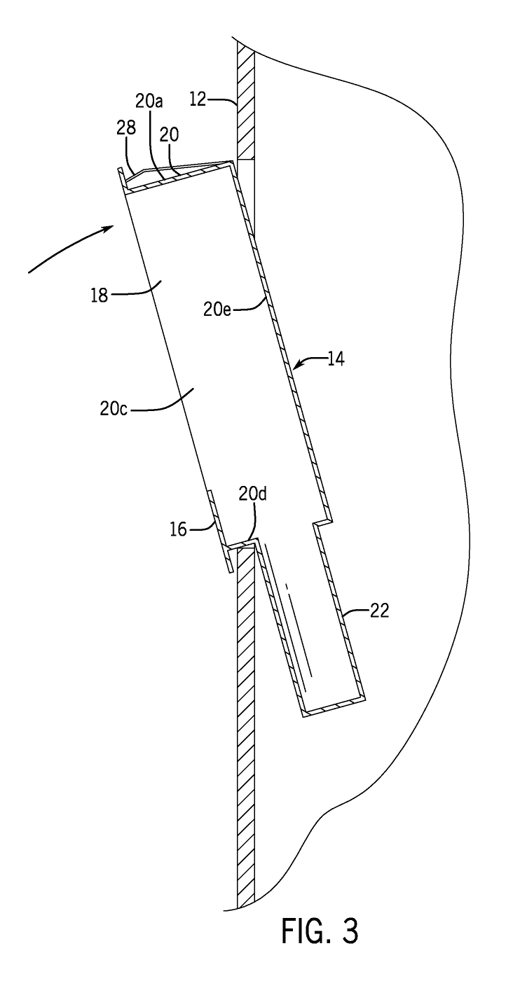

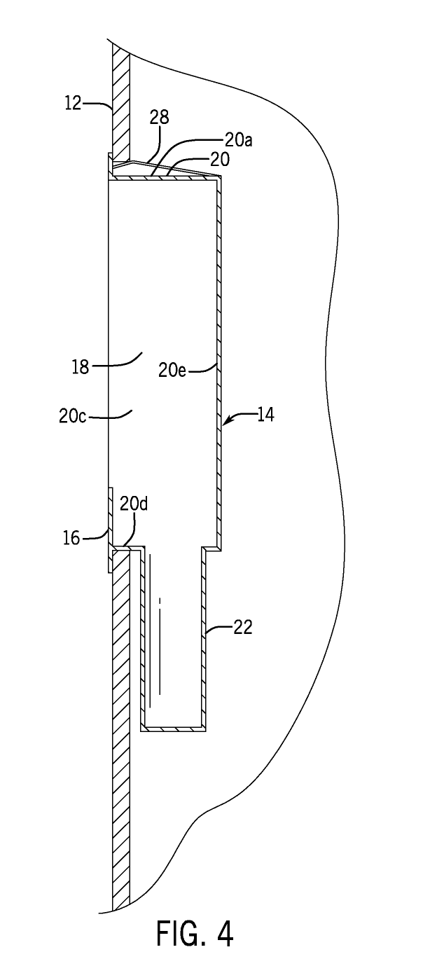

Referring to FIGS. 1 through 4, the present invention includes a storage insert 14 for a writing surface 13. The storage insert 14 includes a frame 20 and a flange 16. The frame 20 includes a top panel 20a, a first side panel 20b, a second side panel 20c and a bottom panel 20d each extending from a back panel 20e. The top panel 20a, the first side panel 20b, the second side panel 20c, and the bottom panel 20d each include a front edge on an opposing side of the back panel 20e. The front edges define an opening leading into a receptacle defined by an inner surface of the frame 20. The flange 16 is coupled to the front edge of the frame 20. The flange 16 projects outward and away from the opening beyond outer surfaces of at least two of the top panel 20a, the first side panel 20b, the second side panel 20c, and the bottom panel 20d. The frame 20 is configured to fit within an opening defined by an inner edge of a writing surface 12 and the flange 16 is configured to retain the frame 20 within the opening.

The frame 20 of the present invention may be an integral piece formed of the above mentioned panels 20a-20e. The frame 20 may be in the shape of a rectangular cuboid having a removed front panel where the opening is formed. The receptacle of the frame 20 is sized and shaped to retain erasers 26 and markers 24 or chalk. In certain embodiments, the bottom panel 20d includes an inner surface defining at least one receptacle 22. The at least one receptacle 22 may include a plurality of receptacles 22. The receptacles may be integral with the bottom panel 20d. Entrances of the receptacles 22 are defined by inner edges of the upper surface of the bottom panel 20d. In certain embodiments, the receptacles 22 may include an inner surface defining a cylindrical shape and an outer surface having the cylindrical shape. In such embodiments, the receptacles 22 may fit markers 24 within.

The flange 16 of the present invention may be perpendicular to the top panel 20a, the bottom panel 20b, the first side panel 20c, and the second side panel 20d. In such embodiments, the flange 16 is parallel to the back panel 20e. The flange may project outward and away from the opening beyond the top panel 20a, the bottom panel 20b, the first side panel 20c, and the second side panel 20d. The flange 16 may abut against an outer surface of the writing surface 13 on all sides. In certain embodiments, the flange 16 may project inward and toward the opening beyond an inner surface of at least the bottom panel 20b. The flange 16 may thereby form a lip for the receptacle of the frame 20 and prevent the eraser 16 and markers 24 or chalk from falling out of the receptacle.

The present invention may further includes at least one locking rib 28. For example, the present invention may include a plurality of locking ribs 28. The locking ribs 28 may releasably retain the storage insert 14 within the opening of the writing surface 13. In certain embodiments, the locking ribs 28 are coupled to the outer surface of the top panel 20a. The locking ribs 28 may include a plurality of angled protrusions made of a resilient material. The angled protrusions may include a leading angle running from the back panel 20e to a trailing angle running towards the flange 16. The leading angle may be smaller than the trailing angle forming an offset triangular shape. When the frame 20 is pushed into the opening, the locking ribs 28 resiliently bend against the inner edge of the writing surface 13. When the frame 20 is fully inserted into the opening, the trailing angle applies a force against the inner edge of the writing surface 13, releasably retaining the frame within the opening.

The writing surface 13 may be part of a dry erase board or chalk board 12. The dry erase board 12 may be a transparent or opaque glass board or may be a white, colored, or decorative board of any other material. The opening is formed in the writing surface 13 of the dry erase board or chalk board 12 and the storage insert 14 fits within the opening, and may substantially extend beyond the opening behind a rear surface of the writing surface forming a recessed receptacle to store markers 26, chalk, erasers, or for any other use, with the flange 16 being substantially flush and flat with the front surface of the writing surface 13, preventing injuries and improving the aesthetics. Additional storage space and utility are made apparent by the extension of the storage insert 14 behind the writing surface, and thereby taking up a larger area than the opening in the writing surface 13 itself.

It should be understood, of course, that the foregoing relates to exemplary embodiments of the invention and that modifications may be made without departing from the spirit and scope of the invention as set forth in the following claims.

What is claimed is:

1. A storage insert for a writing surface comprising:
a frame comprising a top panel, a first side panel, a second side panel, a bottom panel and a back panel, wherein the top panel, the first side panel, the second side panel, and the bottom panel comprise a front edge defining an opening leading into a receptacle defined by an inner surface of the frame; and
a flange coupled to the front edge of the frame, wherein the flange projects outward and away from the opening beyond outer surfaces of at least two of the top panel, the first side panel, the second side panel, and the bottom panel, wherein
the frame is configured to fit within an opening defined by an inner edge of a writing surface and the flange is configured to retain the frame within the opening.

2. The storage insert of claim 1, wherein the flange projects outward and away from the opening beyond the top panel and the lower panel.

3. The storage insert of claim 2, further comprising locking ribs coupled to the outer surface of the top panel.

4. The storage insert of claim 3, wherein the locking ribs comprise a plurality of angled protrusions made of a resilient material.

5. The storage insert of claim 1, wherein the flange further projects inward and toward the opening beyond an inner surface of at least the bottom panel.

6. The storage insert of claim 1, wherein the flange is perpendicular to the top panel, the bottom panel, the first side panel and the second side panel, and the flange is parallel to the back panel.

7. The storage insert of claim 1, wherein the bottom panel comprises an inner surface defining at least one receptacle.

8. The storage insert of claim 7, wherein the at least one receptacle comprises a plurality of marker receptacles, each comprising an inner surface defining a cylinder shape.

9. The storage insert of claim 1, further comprising at least one of a dry erase board and a chalk board comprising the writing surface, wherein the writing surface is substantially planar.

10. The storage insert of claim 9, wherein a substantial portion of the frame extends beyond a rear surface of the at least one of the dry erase board and the chalk board.

11. A storage insert for a writing surface comprising:
a frame comprising a top panel, a first side panel, a second side panel, a bottom panel and a back panel, wherein the top panel, the first side panel, the second side panel, and the bottom panel comprise a front edge defining an opening leading into a receptacle defined by an inner surface of the frame;
a flange coupled to the front edge of the frame, wherein the flange projects outward and away from the opening beyond outer surfaces of at the top panel and the bottom panel; and
at least one locking rib coupled to the outer surface of the top panel, wherein the locking rib is an angled protrusion made of a resilient material, wherein
the frame is configured to fit within an opening defined by an inner edge of a writing surface and the at least one lock rib is configured to resiliently bend and apply a force against the writing surface.
